(19) United States
(12) Patent Application Publication
(10) Pub. No.: US 2012/0011083 A1
(43) Pub. Date: Jan. 12, 2012

(54) Product-Centric Automatic Software Identification in z/OS Systems

(75) Inventors: Thomas Carr Storms, Lincoln Park, NJ (US); Steven R. Youchnow, Manalpan, NJ (US)

(73) Assignee: International Business Machines Corporation, Armonk, NY (US)

(21) Appl. No.: 12/832,423

(22) Filed: Jul. 8, 2010

(51) Int. Cl. G06F 15/18; G06N 5/02

(52) U.S. Cl. 706/12; 706/54

(57) ABSTRACT

A software identification manager selects a unique software module that corresponds to a single knowledge base software product. Next, the software identification manager determines that one or more software modules included in a raw inventory corresponds to the unique software module and, in turn, the software identification manager includes the single knowledge base software product into a refined group of knowledge base software products. The software identification manager then matches one of the knowledge base software products included in the refined group of knowledge base software products to one of the related raw inventory software modules. Once the software identification manager identifies a match, the software identification manager stores a module identification entry in a storage area and associates the matched raw inventory software module to the matched knowledge base software product.

### TECHNICAL FIELD

The present disclosure relates to identifying software modules in a z/OS system using a product-centric discovery process.

### BACKGROUND

Computer systems today provide a user with a variety of software applications. These software applications may be at various versions/releases (e.g, version 1, 2, 3, etc.). In many cases, when a computer system updates a software application to a different version/release, the software application does not require the computer system to update all software modules for the software application. Rather, the software application update may include a portion of the software modules, while the remaining software modules are unchanged. As such, the computer system may include software modules corresponding to products at various version/releases.

### SUMMARY

A software identification manager selects a unique software module that corresponds to a single knowledge base software product. Next, the software identification manager determines that one or more software modules included in a raw inventory corresponds to the unique software module and, in turn, the software identification manager includes the single knowledge base software product into a refined group of knowledge base software products. The software identification manager then matches one of the knowledge base software products included in the refined group of knowledge base software products to one of related raw inventory software modules. Once the software identification manager identifies a match, the software identification manager stores a module identification entry in a storage area and associates the matched raw inventory software module to the matched knowledge base software product.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE DRAWINGS

The present disclosure may be better understood, and its numerous objects, features, and advantages made apparent to those skilled in the art by referencing the accompanying drawings, wherein:

FIG. 1 is a diagram showing a software identification manager identifying raw inventory software modules using information included in a knowledge base;

FIG. 2A is a diagram showing a knowledge base storage area that includes modules for particular product version/releases along with associated product library signatures;

FIG. 2B is a diagram showing software modules included in a raw inventory;

FIG. 3 is a diagram showing a knowledge base table that is generated from a knowledge base;

FIG. 4 is a diagram showing a raw inventory table that is generated from a raw inventory;

FIG. 5 is a high level flowchart showing steps taken in matching knowledge base modules to raw inventory modules;

FIG. 6 is a flowchart showing steps taken in refining a raw inventory table based upon knowledge base table entries;

FIG. 7 is a flowchart showing steps taken in refining a knowledge base table based upon product-unique software modules and unique software module signatures;

FIG. 8 is a flowchart showing steps taken in associating raw inventory software modules to product version/releases using library signature and namespace information;

FIG. 9 is a flowchart showing steps taken in matching raw inventory table entries to knowledge base table entries by spanning across raw inventory program libraries;

FIG. 10 is a block diagram example of a data processing system in which the methods described herein can be implemented; and

FIG. 11 provides an extension example of the information handling system environment shown in FIG. 10 to illustrate that the methods described herein can be performed on a wide variety of information handling systems which operate in a networked environment.

### DETAILED DESCRIPTION

Certain specific details are set forth in the following description and figures to provide a thorough understanding of various embodiments of the disclosure. Certain well-known details often associated with computing and software technology are not set forth in the following disclosure, however, to avoid unnecessarily obscuring the various embodiments of the disclosure. Further, those of ordinary skill in the relevant art will understand that they can practice other embodiments of the disclosure without one or more of the details described below. Finally, while various methods are described with reference to steps and sequences in the following disclosure, the description as such is for providing a clear implementation of embodiments of the disclosure, and the steps and sequences of steps should not be taken as required to practice this disclosure. Instead, the following is intended to provide a detailed description of an example of the disclosure and should not be taken to be limiting of the disclosure itself. Rather, any number of variations may fall within the scope of the disclosure, which is defined by the claims that follow the description.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The following detailed description will generally follow the summary of the disclosure, as set forth above, further explaining and expanding the definitions of the various aspects and embodiments of the disclosure as necessary.

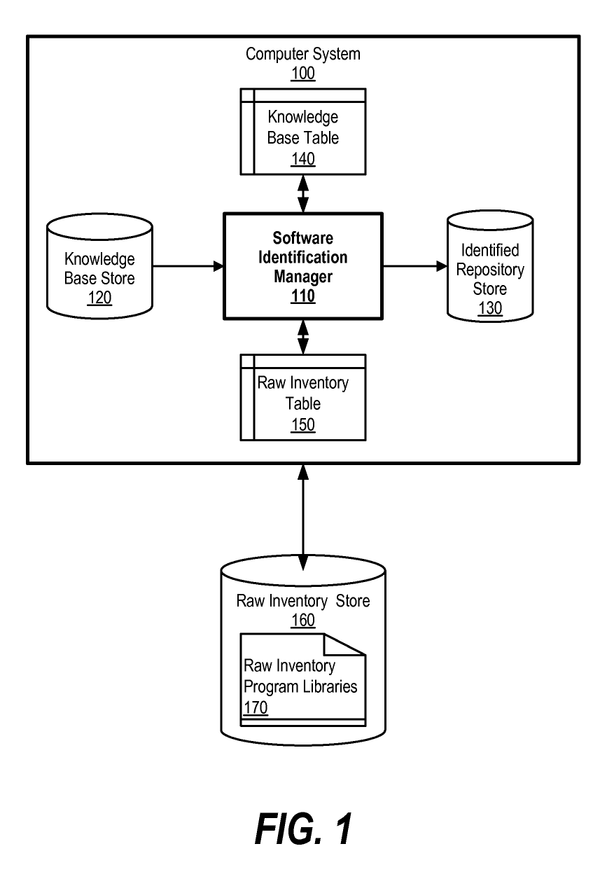

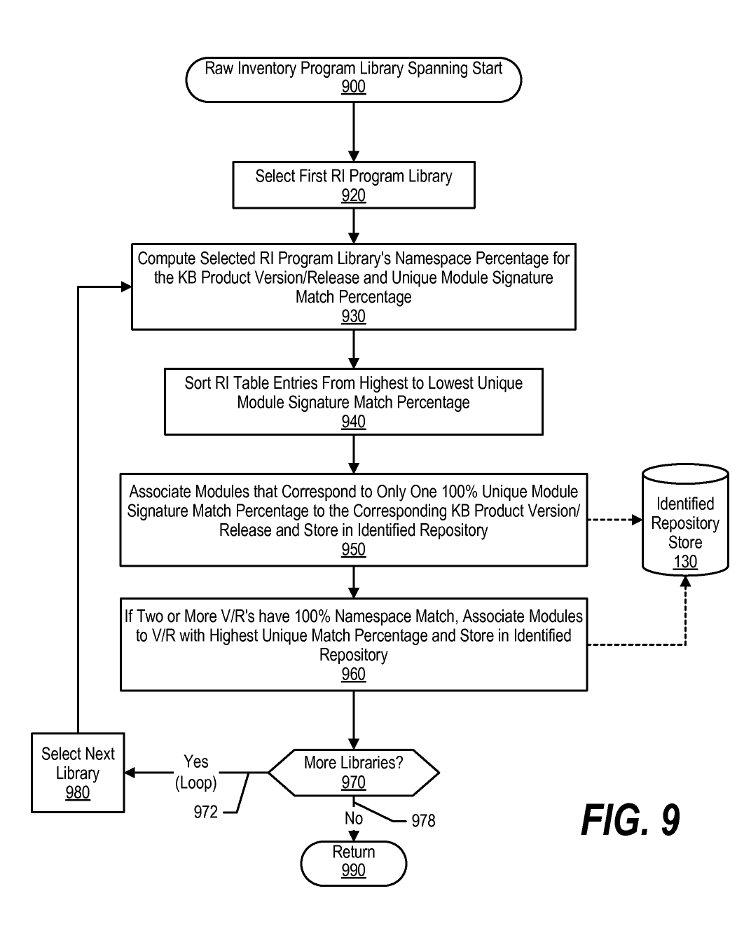

FIG. 1 is a diagram showing a software identification manager identifying raw inventory software modules using information included in a knowledge base. Computer system 100 includes software identification manager 110, which identifies software modules located in raw inventory store by comparing the raw inventory software modules with product information stored in knowledge base store 120. Software identification manager 100 identifies a relationship between the raw inventory software modules and knowledge base software products using a “product-centric” approach. Meaning, software identification manager 110 eliminates ambiguity between software modules of different products by selecting a particular knowledge base product and comparing the selected product's software modules to raw inventory store 160's software modules (see FIG. 8 and corresponding text for further details). In one embodiment, computer system 100 operates in a z/OS environment.

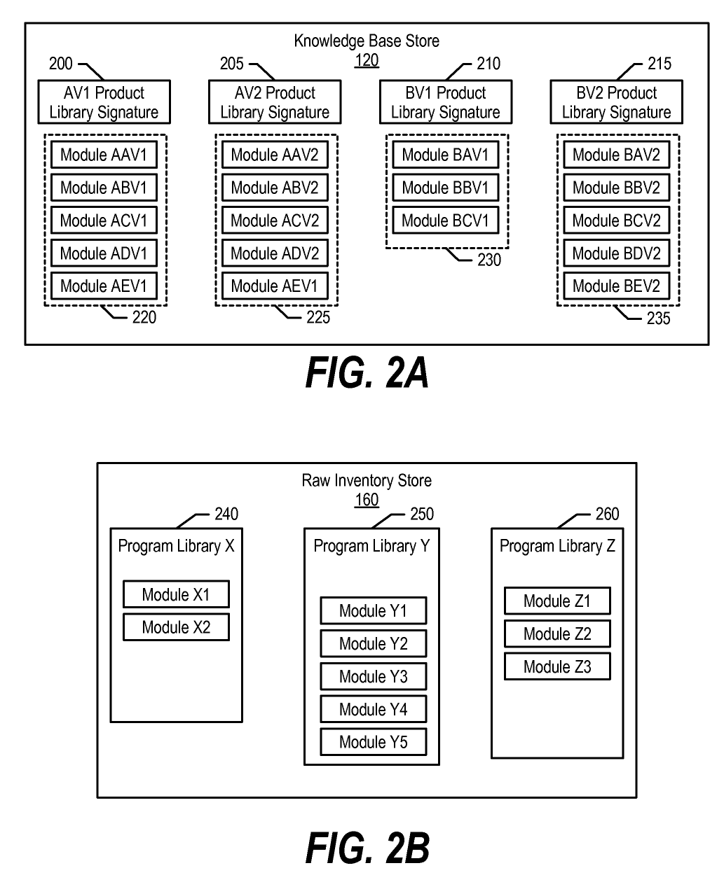

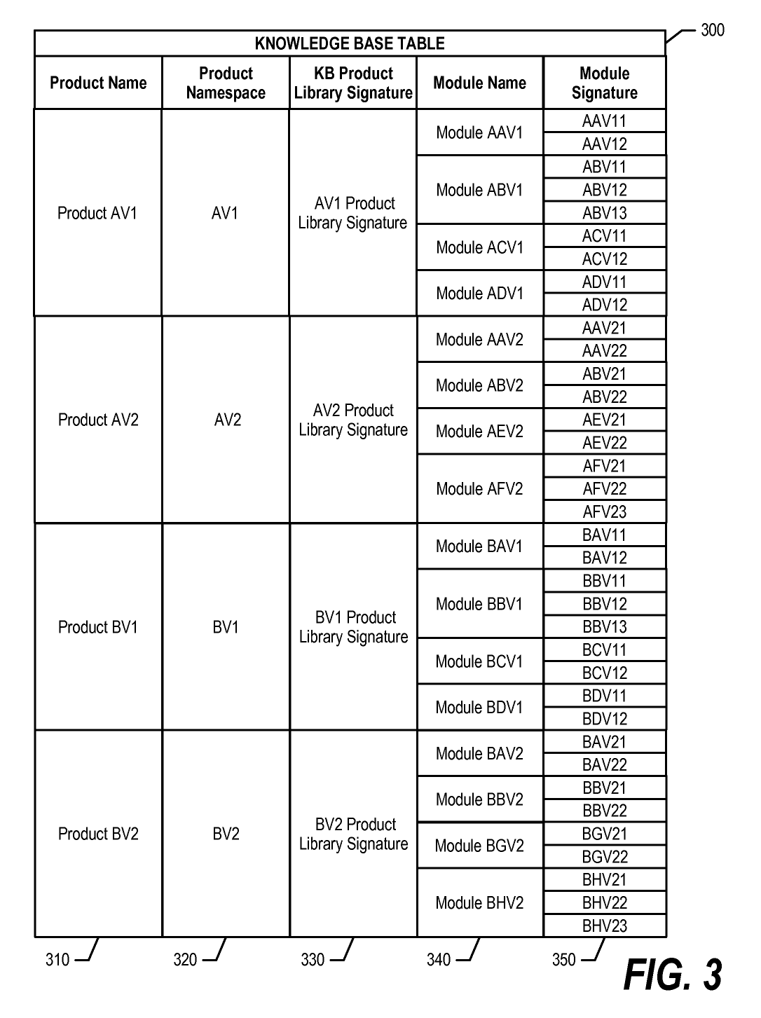

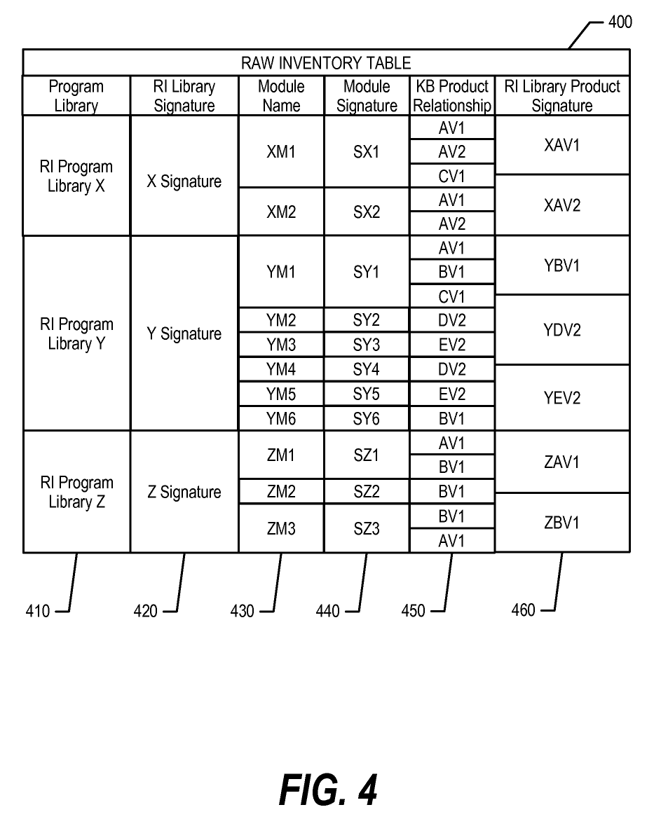

Knowledge base store 120 includes product library signatures and corresponding software module signatures based upon product version/releases. For example, a product library signature may identify a particular product (e.g., product A) and a particular version/release (e.g., version 1) (see FIG. 2A and corresponding text for further details). In one embodiment, software module signatures include sufficient information to uniquely identify each instance of a product module and its version/release. Software identification manager 110 generates knowledge base table 140 from information stored in knowledge base store 120. Knowledge base table 140 includes knowledge base table entries according to product version/release. In one embodiment, the knowledge base table entries include a product name, a product namespace, a knowledge base product library signature, module names, and corresponding module signatures (see FIG. 3 and corresponding text for further details).

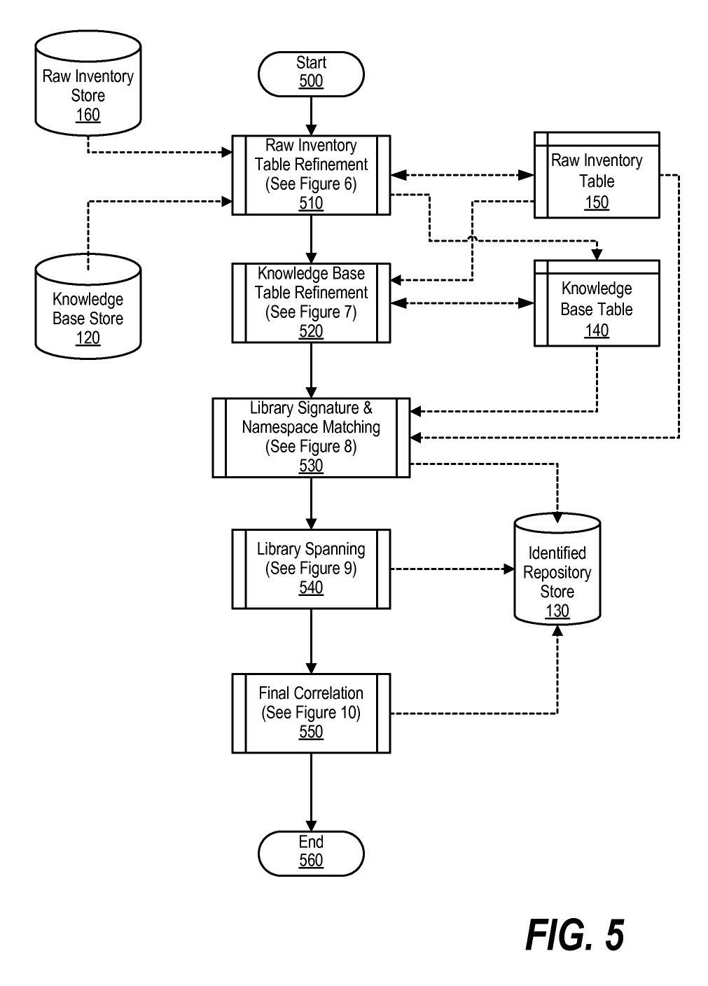

In addition, software identification manager 110 generates raw inventory table 150 from information stored in raw inventory store 160. Raw inventory store 160 includes raw inventory program libraries 170. Each of raw inventory program libraries 170 includes raw inventory software modules. Raw inventory table 150 includes raw inventory table entries that, in one embodiment, include a program library, a raw inventory library signature, a raw inventory library product signature, module names, and corresponding module signatures (see FIG. 4 and corresponding text for further details).

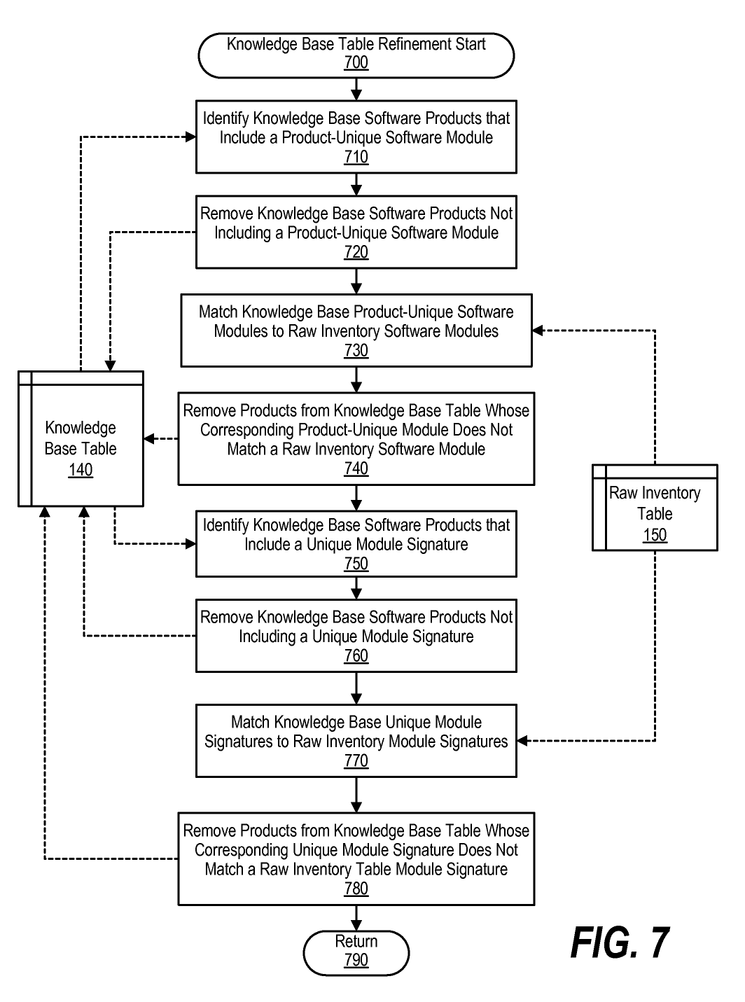

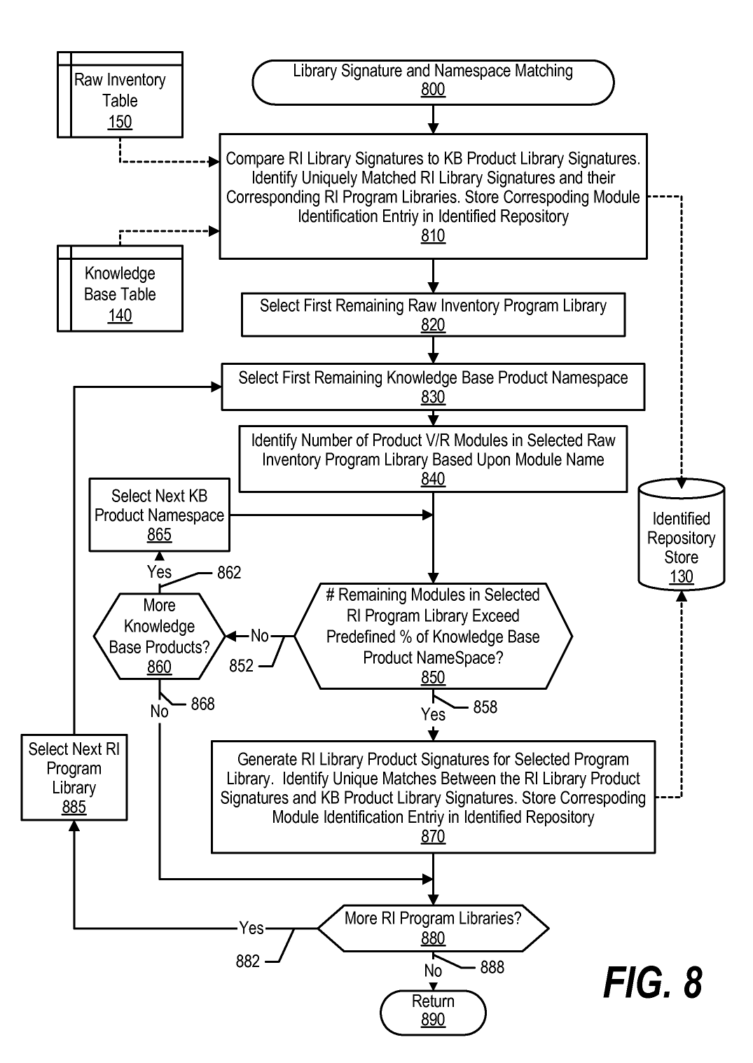

Software identification manager 110 refines raw inventory table 150 (e.g., identifies a subset of raw inventory table entries) by removing table entries that have software modules which are not included in knowledge base table 140 (see FIG. 6 and corresponding text for further details). Next, software identification manager 110 prunes knowledge base table 140 (e.g., identifies a subset of knowledge base table entries) by removing table entries whose products have unique software modules that are not included in raw inventory table 150 (eliminating product definitions not represented in raw inventory table 150). For example, product “G” may have a product-unique software module GAV2 and, in this example, raw inventory table 150 does not include an entry with the software module GAV2. As such, raw inventory table 150 does not include software modules pertaining to product G and, therefore, software identification manager 110 removes knowledge base table entries pertaining to product “G” from knowledge base table 140. In one embodiment, software identification manager 110 also refines knowledge base table 140 based upon product version/releases using a similar approach (see FIG. 7 and corresponding text for further details).

Software identification manager 110 then proceeds through an iterative process to associate raw inventory table entries in raw inventory table 150 with particular knowledge base software product version/releases represented in knowledge base table 140. In turn, software identification manager stores module identification entries in identified repository store 130 that associates raw inventory software modules to particular knowledge base software products (see FIGS. 8-10 and corresponding text for further details).

FIG. 2A is a diagram showing a knowledge base storage area that includes modules for particular product version/releases along with associated product library signatures. Knowledge base 120 is the same as that shown in FIG. 1, and includes modules for four different product version/releases, which are product “A,” versions “1” and “2” along with product “B,” versions “1” and “2.” As those skilled in the art can appreciate, knowledge base store 120 may include more or less modules to represent more or less product version/releases than what FIG. 2A shows.

Each of product library signatures 200-215 identifies a particular product (e.g., product A) and a particular version/release (e.g., version 1). In one embodiment, a product library signature may include multiple fields. In this embodiment, one of the fields may include a number of version/release modules corresponding to the particular product version/release, and another one of the fields may include a signature that is generated from all of the respective version/release modules. Product library signature 200 corresponds to product AV1 modules 220. Product library signature 205 corresponds to product AV2 modules 225. Product library signature 210 corresponds to product BV1 modules 230. And, product library signature 215 corresponds to product BV2 modules 235.

In one embodiment, knowledge base store 120 includes module signatures for each of the software modules. In another embodiment, knowledge base store 120 defines vendor common code as separate products. In yet another embodiment, No two products (except v/r within the same product) may have the same namespace. In yet another embodiment, a software catalog includes a product library signature for each of a product's version/release library where a specified product version/release is identified.

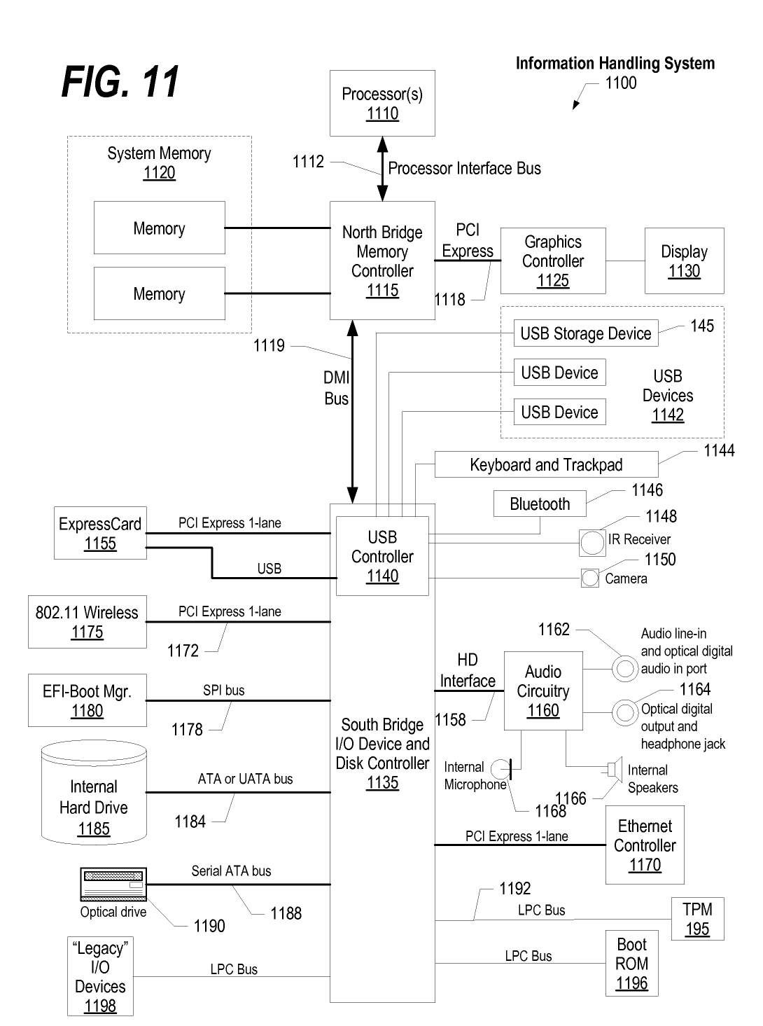

FIG. 2B is a diagram showing software modules included in a raw inventory. Raw inventory store 160 includes program libraries and corresponding software modules. Some of the software modules included in raw inventory store 160 correspond to one or more of the products represented in knowledge base store 120, while other software modules included in raw inventory store 160 may not be associated with products represented in knowledge base store 120 (see FIG. 10 and corresponding text for further details).

Raw inventory store 160 includes three program libraries, which are program library X 240, program library Y 250, and program library Z 260. As can be seen, program library X 240 includes two modules; program library Y 250 includes five modules; and program library Z 260 includes three modules. As discussed herein, software identification manager 110 scans raw inventory store 160 and generates raw inventory table 160, which software identification manager subsequently utilizes to match raw inventory store 160's software modules with a particular product version/release. (see FIGS. 6-10 and corresponding text for further details). As those skilled in the art can appreciate, raw inventory store 160 may include more or less program libraries and/or more or less modules than what is shown in FIG. 2B.

FIG. 3 is a diagram showing a knowledge base table that is generated from a knowledge base, such as knowledge base store 120 shown in FIG. 2A. Knowledge base table 300 includes columns 310-350. Column 310 includes a list of product version/releases, which are products AV1, AV2, BV1, and BV2. As those skilled in the art can appreciate, knowledge base table 300 may include more or less product names than what is shown in FIG. 3.

Column 320 includes a list of namespaces that correspond to the different product version/releases. In one embodiment, a namespace includes a set of unique module names for a particular product version/release. Column 330 includes a list of knowledge base product library signatures, each one of which corresponding to a particular product version/release. As discussed earlier, a product library signature may include multiple fields, such as a version/release modules number and a signature that is computed from all of the respective version/release modules.

Column 340 includes a list of modules that are organized by corresponding product version/release. Column 350 includes a list of module signatures corresponding to each module. As can be seen, a particular module may have multiple module signatures for a variety of reasons. For example, a module may have multiple module signatures from defect corrections during the life of the release. In this example, depending on the elements utilized to generate the signature (e.g., compile date or module size, for instance), each module may have a different signature for every modification. In one embodiment, a module signature may include a set of fields computed from a module's contents that uniquely identifies the module.

FIG. 4 is a diagram showing a raw inventory table that is generated from a raw inventory, such as raw inventory store 160 shown in FIG. 2B. Table 400 includes columns 410-460. Column 410 includes a list of raw inventory program library names that correspond to program libraries included in the raw inventory. Row 420 includes a list of raw inventory library signatures that, in one embodiment, include a pair of fields that include a number of modules in a corresponding program library and a signature computed from the modules.

Column 430 includes a list of raw inventory software module names that are included in each raw inventory program library. Referencing raw inventory store 160 shown in FIG. 2B, the modules represented in column 430 are organized based upon their corresponding program library. Column 450 includes a list of corresponding module signatures for each module. Column 450 includes a list of knowledge base products that utilize the corresponding modules shown in column 430. In one embodiment, column 450 is generated during step 840 shown in FIG. 8. And, column 460 includes a list of raw inventory library product signatures for knowledge base software products that have two represented modules within the raw inventory program library. For example, raw inventory program library X includes software modules that correspond to both knowledge base software products AV1 and AV2. As such, the software identification manager generates raw inventory library product signatures XAV1 and XAV2 to correspond with both knowledge base software products. The software identification manager is not required to generate a raw inventory library product signature for knowledge base software product CV1 because only one of the software product's modules is included in raw inventory program library X (i.e., XM1). In one embodiment, column 460 is generated during step 870 shown in FIG. 8.

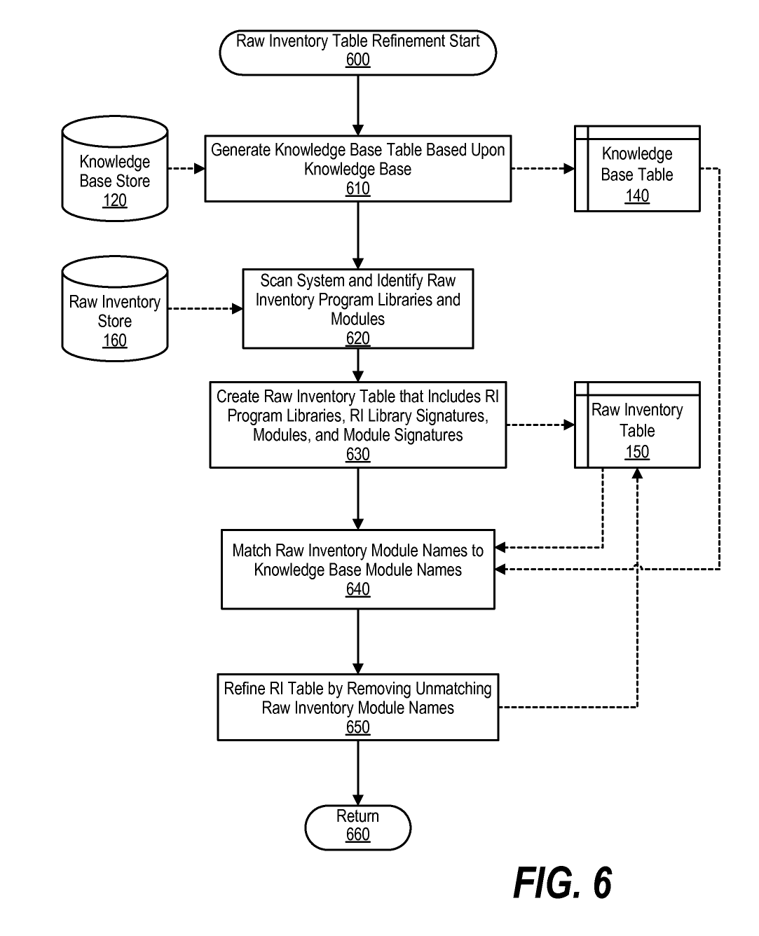

FIG. 5 is a high level flowchart showing steps taken in matching knowledge base modules to raw inventory modules. Processing commences at 500, whereupon processing generates raw inventory table 150 and knowledge base table 140 from raw inventory store 160 and knowledge base table store 120, respectively. In turn, processing refines raw inventory table 150 based upon module names included in knowledge base table 140 (pre-defined process block 510, see FIG. 6 and corresponding text for further details).

Next, processing refines knowledge base table 140 by removing knowledge base software product entries that do not include a product-unique software module that matches a raw inventory software module represented in raw inventory table 150. In turn, knowledge base table 140 represents a refined group of knowledge base software products (pre-defined process block 520, see FIG. 7 and corresponding text for further details).

Processing then uses the refined raw inventory table 150 and the refined knowledge base table 140 to match raw inventory software modules to particular knowledge base software products and store module identification entries in identified repository store 130 that associates the matched raw inventory software modules to the matched knowledge base software products. In one embodiment, processing iteratively removes raw inventory table entries corresponding to the matched raw inventory software modules from raw inventory table 150. (pre-defined process block 530, see FIG. 8 and corresponding text for further details).

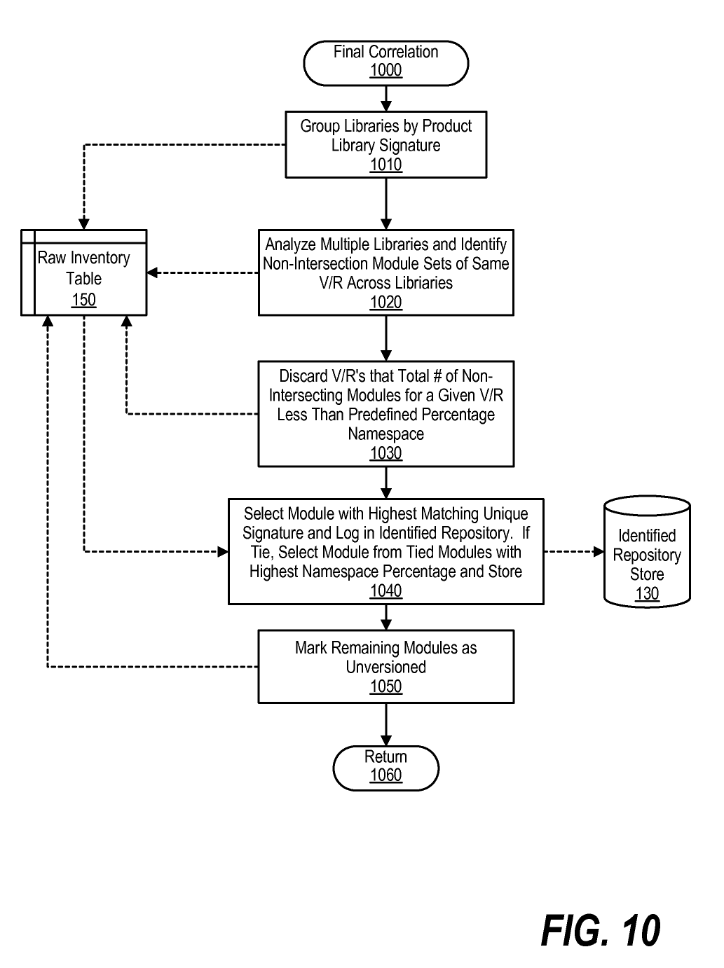

Next, processing spans across raw inventory program libraries to identify software modules on a knowledge base product library signature percentage match basis and stores module identification entries corresponding to the matched modules in identified repository store 130. Again, in one embodiment, processing iteratively removes raw inventory table entries corresponding to the matched raw inventory software modules from raw inventory table 150. (pre-defined process block 540, see FIG. 9 and corresponding text for further details).

Next, processing performs a final attempt to associate unmatched raw inventory software modules to a knowledge base software product based upon a highest matching unique signature (pre-defined process block 550, see FIG. 10 and corresponding text for further details). Processing ends at 560.

FIG. 6 is a flowchart showing steps taken in refining a raw inventory table based upon knowledge base table entries. Processing commences at 600, whereupon processing creates knowledge base table 140 based upon modules and product library signatures included in knowledge base store 120 (step 610). Knowledge base table 140 includes a list of product names, product namespaces, knowledge base product library signatures, module names, and module signatures (see FIG. 3 and corresponding text for further details).

At step 620, processing scans raw inventory store 160 for program libraries and included modules. At step 630, processing generates raw inventory table 150 from the information gathered in step 620, which includes a list of program libraries, corresponding raw inventory library signatures, module names, and module signatures (see FIG. 4 and corresponding text for further details). In one embodiment, library product signatures may be generated and stored in raw inventory store 160 at a later time (see FIG. 8 and corresponding text for further details).

Next, at step 640, processing matches the module names in raw inventory table 150 with the module names in knowledge base table 140. Processing then refines raw inventory table 150 by removing module names (table entries) from raw inventory table 150 that do not have a matching module name in knowledge base table 140 since these raw inventory modules are unidentifiable (step 650). In one embodiment, if a particular raw inventory program library does not include any modules after step 650, processing may also remove the empty raw inventory program library altogether. Processing returns at 660.

FIG. 7 is a flowchart showing steps taken in refining a knowledge base table based upon product-unique software modules and unique software module signatures. Knowledge base table refinement commences at 700, whereupon processing identifies unique knowledge base software modules represented in knowledge base table 140 (step 710). These software modules are unique in the sense that their module name corresponds to a single knowledge base software product. For example, FIG. 3 shows that product BV2 includes module BHV2, which the other three products do not include.

At step 720, processing removes knowledge base table entries corresponding to knowledge base software products that do not include a unique knowledge base software module. This is due to the fact that if a particular knowledge base software product does not include a software module with a unique name, the particular knowledge base software product instills ambiguity into a raw inventory module identification process.

Next, at step 730, processing matches the unique knowledge base software modules with raw inventory table 150 entries and, at step 740, processing removes knowledge base table entries correspond to software products whose unique knowledge base software module does not match with a raw inventory software module. Using the example discussed above, if processing does not match module BHV2 with a raw inventory software module, then raw inventory table 150 does not include modules corresponding to product BV2 and, therefore, processing removes knowledge base table entries corresponding to product BV2 from knowledge base table 140.

Next, processing identifies knowledge base product version/releases that include a unique software module signature (step 750). For example, FIG. 3 shows that module ABV1 has a module signature ABV13 that is unique to product AV1. At step 760, processing removes knowledge base table entries corresponding to knowledge base software products that do not include a unique software module signature. Again, this is due to the fact that if a particular knowledge base software product does not include a unique software module signature, the particular knowledge base software product instills ambiguity into a raw inventory module identification process.

Processing then matches the unique software module signatures to raw inventory software module signatures (step 770), and removes knowledge base software product version/releases from knowledge base table 140 that do not have a corresponding entry in raw inventory table 150 (step 780). At this point knowledge base table 140 represents a refined group of knowledge base software products that each include at least one software module that has a unique software module signature. As those skilled in the art can appreciate, other approaches may be used to generate knowledge base table 140 to represent the refined group of knowledge base software products. Processing returns at 760.

FIG. 8 is a flowchart showing steps taken in associating raw inventory software modules to product version/releases using library signature and namespace information. Processing commences at 800, whereupon processing matches raw inventory library product signatures in raw inventory table 150 to knowledge base product library signatures in knowledge base table 140 (step 810). When processing identifies unique matches, processing stores module identification entries in identified repository store 130 that associates raw inventory software modules to knowledge base software products that correspond with the matched signatures. In one embodiment, processing removes raw inventory table entries corresponding to the matched raw inventory software modules from raw inventory table 150.

Next, processing selects the first remaining raw inventory program library at step 820, and selects the first remaining knowledge base product namespace at step 830. As discussed earlier, a knowledge base software product namespace may include a set of unique module names from each version/release of a knowledge base software product. Processing identifies a number of product version/release modules in the selected raw inventory program library that correspond with the selected knowledge base product namespace (step 840).

A determination is made as to whether a number of corresponding raw inventory software modules exceeds a predefined percentage of knowledge base product namespace (decision 850). For example, if a raw inventory library includes 50% of the modules in a knowledge base software product's namespace, that product may be a candidate for further analysis and possible identification using the steps outlined below. The percentage may be a global value or a per-product value depending on implementation requirements. If the number of corresponding modules exceeds a predefined percentage of knowledge base product namespace, decision 850 branches to “Yes” branch 858, whereupon processing 1) generates raw inventory library product signatures for the selected program library; 2) identifies unique matches between the raw inventory library product signatures and the knowledge base product library signatures corresponding to the selected knowledge base product namespace; and 3) stores module identification entries in identified repository store 130 that associates raw inventory software modules to knowledge base software products that correspond with the matched signatures. (step 870).

On the other hand, if the number of corresponding modules fails to exceed a predefined percentage of knowledge base product namespace, decision 850 branches to “No” branch 852, whereupon a determination is made as to whether there are more knowledge base products to compare with the selected raw inventory program library (decision 860). If there are more products to compare, decision 860 branches to “Yes” branch 862, whereupon processing selects (step 865) and compares the next knowledge base product namespace. This looping continues until there are no more knowledge base products for which to compare, at which point decision 860 branches to “No” branch 868.

A determination is made as to whether there are more raw inventory program libraries to analyze (decision 880). If there are more raw inventory program libraries to analyze, decision 880 branches to “Yes” branch 882, whereupon processing selects (step 885) and analyzes the next raw inventory program library. This looping continues until there are no more raw inventory program libraries to analyze, at which point decision 880 branches to “No” branch 888 whereupon processing returns at 890.

FIG. 9 is a flowchart showing steps taken in matching raw inventory table entries to knowledge base table entries by spanning across raw inventory program libraries. Processing commences at 900, whereupon processing selects the first raw inventory program library and, at step 930, processing computes the selected library's namespace percentage for the version/release and unique software module signature match percentage. For example, for each library, the namespace percentage for the v/r may be computed as:
(100*name_matches)/(#-in-namespace)
   and the percentage of unique software module signature matches may be computed as:
(100*unique_signature_matches)/(#-unique-v/r-signatures)

At step 940, processing sorts the entries from highest to lowest unique software module signature match percentage. Processing then associates table entries corresponding to a single 100% unique software module signature match percentage to a product version/release, and stores module identification entries in identified repository store 130 accordingly (step 950). In addition, when two or more product version/releases have a 100% namespace match, processing associate the corresponding table entries to the product version/release with the highest unique match percentage, and stores module identification entries in identified repository store 130 accordingly.

A determination is made as to whether there are more raw inventory program libraries for which to analyze (decision 970). If there are more libraries to analyze, decision 970 branches to “Yes” branch 972, whereupon processing selects (step 980) and processes the next raw inventory program library. This looping continues until there are no more raw inventory libraries to analyze, at which point decision 970 branches to “No” branch 978 whereupon processing returns at 990.

FIG. 10 is a flowchart showing steps taken in associating raw inventory table entries to knowledge base table entries based upon highest relative matching unique signatures. Processing commences at 1000, whereupon processing groups raw inventory program libraries by product library signature (step 1010). In one embodiment, when two or more raw inventory program libraries have the same signature, processing may identify products in one of the libraries and apply identifications to the other libraries having the same signature.

Next, processing attempts to associate a product version/release namespace by analyzing multiple raw inventory program libraries and identifying non-intersecting module sets of the same version/releases across the different libraries (step 1020). A non-intersecting module set is a set of two or more libraries at the same product version/release level that has no modules in common or, when common modules exist, they are the same module (e.g., match by signature).

When a total number of non-intersecting modules for a given version/release is less than predefined percentage of the namespace, processing discards that particular version/release as a possible match at step 1030. Next, at step 1040, processing selects the raw inventory modules with the highest matching unique signature percentage. When a tie results, processing selects the highest namespace percentage among the tied modules. Processing then stores module identification entries corresponding to the selected raw inventory table entries in identified repository store 130.

At this point, the remaining raw inventory modules may not be associated with a definitive knowledge base product version/release. As such, processing marks the remaining modules as un-versioned at step 1050, and processing returns at 1060.

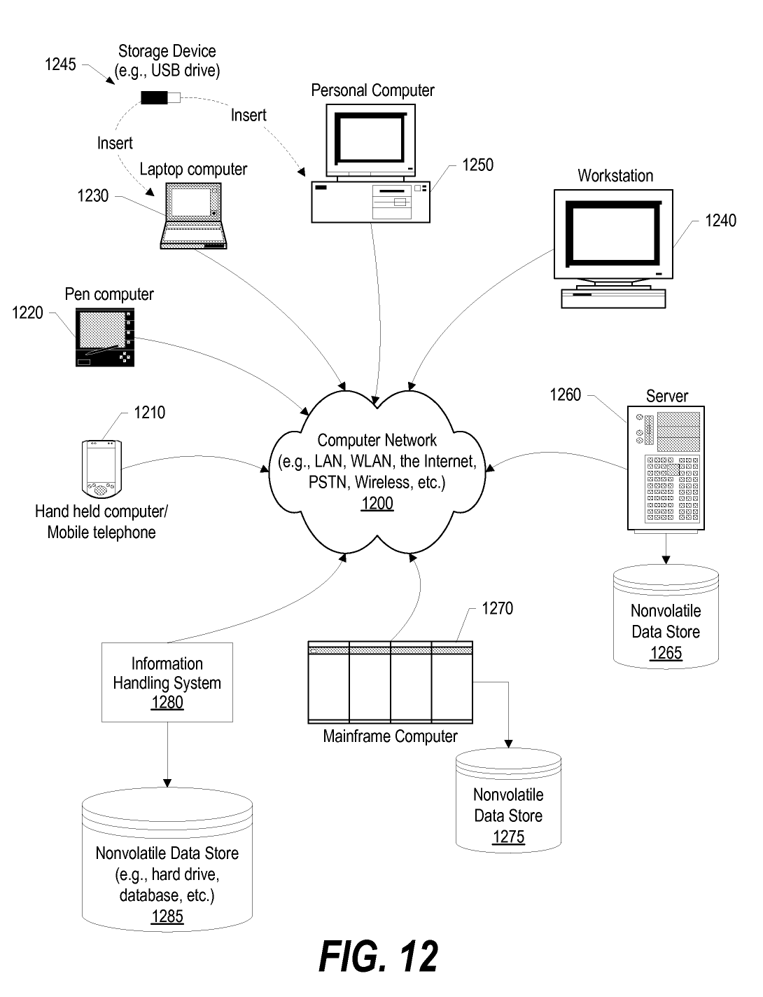

FIG. 11 illustrates information handling system 1100, which is a simplified example of a computer system capable of performing the computing operations described herein. Information handling system 1100 includes one or more processors 1110 coupled to processor interface bus 1112. Processor interface bus 1112 connects processors 1110 to Northbridge 1115, which is also known as the Memory Controller Hub (MCH). Northbridge 1115 connects to system memory 1120 and provides a means for processor(s) 1110 to access the system memory. Graphics controller 1125 also connects to Northbridge 1115. In one embodiment, PCI Express bus 1118 connects Northbridge 1115 to graphics controller 1125. Graphics controller 1125 connects to display device 1130, such as a computer monitor.

Northbridge 1115 and Southbridge 1135 connect to each other using bus 1119. In one embodiment, the bus is a Direct Media Interface (DMI) bus that transfers data at high speeds in each direction between Northbridge 1115 and Southbridge 1135. In another embodiment, a Peripheral Component Interconnect (PCI) bus connects the Northbridge and the Southbridge. Southbridge 1135, also known as the I/O Controller Hub (ICH) is a chip that generally implements capabilities that operate at slower speeds than the capabilities provided by the Northbridge. Southbridge 1135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 1196 and “legacy” I/O devices (using a “super I/O” chip). The “legacy” I/O devices (1198) can include, for example, serial and parallel ports, keyboard, mouse, and/or a floppy disk controller. The LPC bus also connects Southbridge 1135 to Trusted Platform Module (TPM) 1195. Other components often included in Southbridge 1135 include a Direct Memory Access (DMA) controller, a Programmable Interrupt Controller (PIC), and a storage device controller, which connects Southbridge 1135 to nonvolatile storage device 1185, such as a hard disk drive, using bus 1184.

ExpressCard 1155 is a slot that connects hot-pluggable devices to the information handling system. ExpressCard 1155 supports both PCI Express and USB connectivity as it connects to Southbridge 1135 using both the Universal Serial Bus (USB) the PCI Express bus. Southbridge 1135 includes USB Controller 1140 that provides USB connectivity to devices that connect to the USB. These devices include webcam (camera) 1150, infrared (IR) receiver 1148, keyboard and trackpad 1144, and Bluetooth device 1146, which provides for wireless personal area networks (PANs). USB Controller 1140 also provides USB connectivity to other miscellaneous USB connected devices 1142, such as a mouse, removable nonvolatile storage device 1145, modems, network cards, ISDN connectors, fax, printers, USB hubs, and many other types of USB connected devices. While removable nonvolatile storage device 1145 is shown as a USB-connected device, removable nonvolatile storage device 1145 could be connected using a different interface, such as a Firewire interface, etcetera.

Wireless Local Area Network (LAN) device 1175 connects to Southbridge 1135 via the PCI or PCI Express bus 1172. LAN device 1175 typically implements one of the IEEE 802.11 standards of over-the-air modulation techniques that all use the same protocol to wirelessly communicate between information handling system 1100 and another computer system or device. Optical storage device 1190 connects to Southbridge 1135 using Serial ATA (SATA) bus 1188. Serial ATA adapters and devices communicate over a high-speed serial link. The Serial ATA bus also connects Southbridge 1135 to other forms of storage devices, such as hard disk drives. Audio circuitry 1160, such as a sound card, connects to Southbridge 1135 via bus 1158. Audio circuitry 1160 also provides functionality such as audio line-in and optical digital audio in port 1162, optical digital output and headphone jack 1164, internal speakers 1166, and internal microphone 1168. Ethernet controller 1170 connects to Southbridge 1135 using a bus, such as the PCI or PCI Express bus. Ethernet controller 1170 connects information handling system 1100 to a computer network, such as a Local Area Network (LAN), the Internet, and other public and private computer networks.

While FIG. 11 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 1195) shown in FIG. 11 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 12.

FIG. 12 provides an extension example of the information handling system environment shown in FIG. 11 to illustrate that the methods described herein can be performed on a wide variety of information handling systems that operate in a networked environment. Types of information handling systems range from small handheld devices, such as handheld computer/mobile telephone 1210 to large mainframe systems, such as mainframe computer 1270. Examples of handheld computer 1210 include personal digital assistants (PDAs), personal entertainment devices, such as MP3 players, portable televisions, and compact disc players. Other examples of information handling systems include pen, or tablet, computer 1220, laptop, or notebook, computer 1230, workstation 1240, personal computer system 1250, and server 1260. Other types of information handling systems that are not individually shown in FIG. 12 are represented by information handling system 1280. As shown, the various information handling systems can be networked together using computer network 1200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 12 depicts separate nonvolatile data stores (server 1260 utilizes nonvolatile data store 1265, mainframe computer 1270 utilizes nonvolatile data store 1275, and information handling system 1280 utilizes nonvolatile data store 1285). The nonvolatile data store can be a component that is external to the various information handling systems or can be internal to one of the information handling systems. In addition, removable nonvolatile storage device 1245 can be shared among two or more information handling systems using various techniques, such as connecting the removable nonvolatile storage device 1245 to a USB port or other connector of the information handling systems.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

What is claimed is:

1. A machine-implemented method comprising:
selecting a unique software module corresponding to a single knowledge base software product;
determining that one or more of a plurality of raw inventory software modules included in a raw inventory storage area corresponds to the unique software module;
including the single knowledge base software product into a refined group of knowledge base software products in response to the determination;
matching one of the plurality of raw inventory software modules to one of the knowledge base software products included in the refined group of knowledge base software products; and
storing, in response to the matching, one or more module identification entries in a storage area that associates the matched raw inventory software module to the matched knowledge base software product.

2. The method of claim 1 wherein:
the unique software module includes a unique software module signature that differentiates the unique software module from each of a plurality of knowledge base software modules included in a knowledge base storage area; and
each of the knowledge base knowledge base software products included in refined group of knowledge base software products corresponds to a different unique software module that includes a different unique software module signature.

3. The method of claim 1 further comprising:
generating a refined knowledge base table, wherein the refined knowledge base table includes a plurality of knowledge base table entries that each correspond to one of a plurality of knowledge base software modules corresponding to one of the knowledge base software products included in the refined group of knowledge base software products; and
generating a raw inventory table, wherein the raw inventory table includes a plurality of raw inventory table entries that each correspond to one of the plurality of raw inventory software modules.

4. The method of claim 3 wherein the raw inventory table includes a raw inventory program library signature corresponding to a raw inventory program library included in the raw inventory storage area, and wherein the knowledge base table includes a knowledge base product library signature corresponding to one of the knowledge base software products included in refined group of knowledge base software products, the method further comprising:
matching the raw inventory program library signature to the knowledge base product library signature;
identifying one or more of the plurality of raw inventory table entries that correspond to the matched raw inventory program library; and
storing one or more of the module identification entries that each associates one of the identified one or more raw inventory table entries to the knowledge base software product that corresponds to the matched knowledge base product library signature.

5. The method of claim 3 wherein the knowledge base table includes a knowledge base product namespace, the knowledge base product namespace corresponding to one of the knowledge base software products included in the refined group of knowledge base software products, the method further comprising:
selecting a raw inventory program library that is represented in the raw inventory table;
identifying one or more of the plurality of raw inventory software modules that correspond to the selected raw inventory program library;
determining that a percentage of the one or more identified raw inventory software modules that match the knowledge base product namespace exceeds a predefined threshold; and
generating, in response to the determination, one or more raw inventory library product signatures for the selected raw inventory program library, wherein each of the one or more raw inventory library product signatures corresponds to one of the knowledge base software products included in the refined group of knowledge base software products.

6. The method of claim 5 further comprising:
identifying a unique match between one of the raw inventory library signatures and a knowledge base product library signature, the knowledge base product library signature corresponding to one of the knowledge base software products included in the refined group of knowledge base software products;
identifying one or more of the raw inventory table entries from the plurality of raw inventory table entries that correspond to the uniquely matching raw inventory library product signature; and
storing one or more of the module identification entries that each associates one of the identified one or more raw inventory table entries to the software product corresponding to the matched knowledge base product library signature.

7. The method of claim 3 further comprising:
selecting a raw inventory program library that is represented in the raw inventory table;
identifying one or more of the raw inventory table entries from the plurality of raw inventory table entries that correspond to the raw inventory program library;
computing a unique software module signature match percentage for each of the identified raw inventory table entries;
identifying a uniquely matching raw inventory table entry whose unique software module signature match corresponds to a single knowledge base software product from the plurality of knowledge base software products; and
storing one of the module identification entries that associates the uniquely matching raw inventory table entry to the single knowledge base software product.

8. A computer program product stored in a non-transitory computer readable medium, comprising functional descriptive material that, when executed by an information handling system, causes the information handling system to perform actions that include:
selecting a unique software module corresponding to a single knowledge base software product;
determining that one or more of a plurality of raw inventory software modules included in a raw inventory storage area corresponds to the unique software module;
including the single knowledge base software product into a refined group of knowledge base software products in response to the determination; matching one of the plurality of raw inventory software modules to one of the knowledge base software products included in the refined group of knowledge base software products; and
storing, in response to the matching, one or more module identification entries in a storage area that associates the matched raw inventory software module to the matched knowledge base software product.

9. The computer program of claim 8 wherein:
the unique software module includes a unique software module signature that differentiates the unique software module from each of a plurality of knowledge base software modules included in a knowledge base storage area; and
each of the knowledge base knowledge base software products included in refined group of knowledge base software products corresponds to a different unique software module that includes a different unique software module signature.

10. The computer program of claim 8 wherein the functional descriptive material that, when executed by the information handling system, causes the information handling system to further perform actions that include:
generating a refined knowledge base table, wherein the refined knowledge base table includes a plurality of knowledge base table entries that each correspond to one of a plurality of knowledge base software modules corresponding to one of the knowledge base software products included in the refined group of knowledge base software products; and
generating a raw inventory table, wherein the raw inventory table includes a plurality of raw inventory table entries that each correspond to one of the plurality of raw inventory software modules.

11. The computer program of claim 10 wherein the raw inventory table includes a raw inventory program library signature corresponding to a raw inventory program library included in the raw inventory storage area, and wherein the knowledge base table includes a knowledge base product library signature corresponding to one of the knowledge base software products included in refined group of knowledge base software products, and wherein the functional descriptive material that, when executed by the information handling system, causes the information handling system to further perform actions that include:
matching the raw inventory program library signature to the knowledge base product library signature;
identifying one or more of the plurality of raw inventory table entries that correspond to the matched raw inventory program library; and
storing one or more of the module identification entries that each associates one of the identified one or more raw inventory table entries to the knowledge base software product that corresponds to the matched knowledge base product library signature.

12. The computer program of claim 10 wherein the knowledge base table includes a knowledge base product namespace, the knowledge base product namespace corresponding to one of the knowledge base software products included in the refined group of knowledge base software products, and wherein the functional descriptive material that, when executed by the information handling system, causes the information handling system to further perform actions that include:
selecting a raw inventory program library that is represented in the raw inventory table;
identifying one or more of the plurality of raw inventory software modules that correspond to the selected raw inventory program library;
determining that a percentage of the one or more identified raw inventory software modules that match the knowledge base product namespace exceeds a predefined threshold; and
generating, in response to the determination, one or more raw inventory library product signatures for the selected raw inventory program library, wherein each of the one or more raw inventory library product signatures corresponds to one of the knowledge base software products included in the refined group of knowledge base software products.

13. The computer program of claim 12 wherein the functional descriptive material that, when executed by the information handling system, causes the information handling system to further perform actions that include:
identifying a unique match between one of the raw inventory library signatures and a knowledge base product library signature, the knowledge base product library signature corresponding to one of the knowledge base software products included in the refined group of knowledge base software products;
identifying one or more of the raw inventory table entries from the plurality of raw inventory table entries that correspond to the uniquely matching raw inventory library product signature; and
storing one or more of the module identification entries that each associates one of the identified one or more raw inventory table entries to the software product corresponding to the matched knowledge base product library signature.

14. The computer program of claim 10 wherein the functional descriptive material that, when executed by the information handling system, causes the information handling system to further perform actions that include:
selecting a raw inventory program library that is represented in the raw inventory table;
identifying one or more of the raw inventory table entries from the plurality of raw inventory table entries that correspond to the raw inventory program library;
computing a unique software module signature match percentage for each of the identified raw inventory table entries;
identifying a uniquely matching raw inventory table entry whose unique software module signature match corresponds to a single knowledge base software product from the plurality of knowledge base software products; and
storing one of the module identification entries that associates the uniquely matching raw inventory table entry to the single knowledge base software product.

15. An information handling system comprising:
one or more processors;
a memory accessible by at least one of the processors;
a set of instructions stored in the memory and executed by at least one of the processors in order to perform actions of:
selecting a unique software module corresponding to a single knowledge base software product;
determining that one or more of a plurality of raw inventory software modules included in a raw inventory storage area located in the memory corresponds to the unique software module;
including the single knowledge base software product into a refined group of knowledge base software products in response to the determination;
matching one of the plurality of raw inventory software modules to one of the knowledge base software products included in the refined group of knowledge base software products; and
storing, in response to the matching, one or more module identification entries in the memory that associates the matched raw inventory software module to the matched knowledge base software product.

16. The information handling system of claim 15 wherein:
the unique software module includes a unique software module signature that differentiates the unique software module from each of a plurality of knowledge base software modules included in a knowledge base storage area located in the memory; and
each of the knowledge base knowledge base software products included in refined group of knowledge base software products corresponds to a different unique software module that includes a different unique software module signature.

17. The information handling system of claim 15 wherein the set of instructions, when executed by one of the processors, further performs actions of:
generating a refined knowledge base table, wherein the refined knowledge base table includes a plurality of knowledge base table entries that each correspond to one of a plurality of knowledge base software modules corresponding to one of the knowledge base software products included in the refined group of knowledge base software products; and
generating a raw inventory table, wherein the raw inventory table includes a plurality of raw inventory table entries that each correspond to one of the plurality of raw inventory software modules.

18. The information handling system of claim 17 wherein the raw inventory table includes a raw inventory program library signature corresponding to a raw inventory program library included in the raw inventory storage area, and wherein the knowledge base table includes a knowledge base product library signature corresponding to one of the knowledge base software products included in refined group of knowledge base software products, and wherein the set of instructions, when executed by one of the processors, further performs actions of:
matching the raw inventory program library signature to the knowledge base product library signature;
identifying one or more of the plurality of raw inventory table entries that correspond to the matched raw inventory program library; and
storing one or more of the module identification entries that each associates one of the identified one or more raw inventory table entries to the knowledge base software product that corresponds to the matched knowledge base product library signature.

19. The information handling system of claim 17 wherein the knowledge base table includes a knowledge base product namespace, the knowledge base product namespace corresponding to one of the knowledge base software products included in the refined group of knowledge base software products, and wherein the set of instructions, when executed by one of the processors, further performs actions of:
selecting a raw inventory program library that is represented in the raw inventory table;
identifying one or more of the plurality of raw inventory software modules that correspond to the selected raw inventory program library;
determining that a percentage of the one or more identified raw inventory software modules that match the knowledge base product namespace exceeds a predefined threshold; and
generating, in response to the determination, one or more raw inventory library product signatures for the selected raw inventory program library, wherein each of the one or more raw inventory library product signatures corresponds to one of the knowledge base software products included in the refined group of knowledge base software products.

20. The information handling system of claim 19 wherein the set of instructions, when executed by one of the processors, further performs actions of:
identifying a unique match between one of the raw inventory library signatures and a knowledge base product library signature, the knowledge base product library signature corresponding to one of the knowledge base software products included in the refined group of knowledge base software products;
identifying one or more of the raw inventory table entries from the plurality of raw inventory table entries that correspond to the uniquely matching raw inventory library product signature; and
storing one or more of the module identification entries that each associates one of the identified one or more raw inventory table entries to the software product corresponding to the matched knowledge base product library signature.
